(19) United States
(12) Patent Application Publication
(10) Pub. No.: US 2022/0119224 A1
(43) Pub. Date: Apr. 21, 2022

(54) ELEVATOR MONITORING SYSTEM

(71) Applicant: Otis Elevator Company, Farmington, CT (US)

(72) Inventors: Antoine Blanchard, Chateauneuf sur Loire (FR); Nikola Trcka, West Hartford, CT (US); Romain Marechal, Gien (FR); Karl D. Pedersen, Terryville, CT (US)

(21) Appl. No.: 17/407,511

(22) Filed: Aug. 20, 2021

(30) Foreign Application Priority Data
Oct. 16, 2020 (EP) 20306221.1

(51) Int. Cl. B66B 5/00; B66B 13/02

(52) U.S. Cl. CPC B66B 5/0025; B66B 13/02

(57) ABSTRACT

An elevator monitoring system, includes: one or more sensors; a controller arranged to acquire sensor data from the one or more sensors; analyse the sensor data to identify a first event and a second event, the first event corresponding to an elevator door motion; categorize the first event based on the sensor data for the first event and the second event.

### FOREIGN PRIORITY

This application claims priority to European Patent Application No. 20306221.1, filed Oct. 16, 2020, and all the benefits accruing therefrom under 35 U.S.C. § 119, the contents of which in its entirety are herein incorporated by reference.

### TECHNICAL FIELD

This disclosure generally relates to an elevator monitoring system. More specifically, this disclosure relates to a monitoring system for monitoring an elevator door, in particular categorizing the motion of an elevator car door.

### BACKGROUND OF THE INVENTION

Elevator systems can be monitored in a number of ways in order to establish characteristics relating to the operational health of the elevator system. Some characteristics of particular interest are those relating to travel of the elevator car within the hoistway. Other characteristics of particular interest are those relating to operation of the elevator car door(s) while the elevator car is at a landing.

### SUMMARY

According to a first aspect of this disclosure there is provided an elevator monitoring system, comprising: one or more sensors; a controller arranged to: acquire sensor data from the one or more sensors; analyse the sensor data to identify a first event and a second event, the first event corresponding to an elevator door motion; categorize the first event based on the sensor data for the first event and the second event.

Categorizing the elevator door motion is useful for determining characteristics relating to the health of the elevator door system. For example, the number of times that the elevator car door has opened is a useful indicator of elevator system health (which can be used to indicate a need for maintenance). Additionally or alternatively, the number of times that the elevator car door has undergone a reversal motion is a useful indicator of elevator system health. A reversal motion is a closing motion which commenced, but did not finish, resulting in a re-opening of the elevator door.

Existing systems have used the duration of a detected door motion to categorize it based on the principle that a door reversal motion generally takes longer than a door opening or door closing motion. For example, in a door reversal motion the door will undergo a partial closing operation and a partial opening operation which together will generally be longer than an individual opening motion or an individual closing operation, e.g. where the reversal was caused by an obstruction between the doors when they were nearly fully closed. However, short door reversal operations can also occur, e.g. where an obstruction blocks the door very shortly after commencement of door closing. In such cases the duration of door motion may be less than a normal opening or closing operation and can be missed by analysis based purely on duration. By contrast, the system of this disclosure categorizes the elevator door motion based on both a first event and a second event in the sensor data. This improves the reliability of categorization by taking into account additional information indicative of the type of motion occurring in the elevator door. In particular, by using two separate events in the analysis, the system can base the categorization on events that happened before or after the elevator door motion event and which are thus indicative of the state of the system at the corresponding time.

The sensor(s) that are used in the elevator monitoring system may include any number of different sensors such as pressure sensors, light sensors, sound sensors, cameras, infrared detectors, load sensors, etc. In some examples the one or more sensors comprises an accelerometer and the controller is arranged to acquire accelerometer data. An accelerometer can be used to detect accelerations (including vibrations) in the system and these can be used to identify (amongst other things) movement of the elevator car doors. The one or more sensors may additionally comprise other sensors. For example, the one or more sensors may comprise a pressure sensor which may be used in the determination of the start and stop of vertical elevator car motion within the hoistway.

In some examples the controller is arranged to analyse the accelerometer data to identify the first event. In some examples the controller may be arranged to analyse the accelerometer data to identify the second event. In some examples the controller may be arranged to use other sensor data (e.g. pressure sensor data) to identify the second event.

In some examples identifying the first event comprises identifying a period of elevator door motion between two periods of the elevator door being stationary. Door motion tends to be represented by a continuous period of significant (i.e. relatively high) acceleration in the accelerometer data. Such continuous period of acceleration may be from a fully closed door state to a fully open door state (a normal opening motion), or it may be from a fully open door state to a fully closed door state (a normal closing motion), or it may be from a fully open door state to a partially open/closed door state and back to a fully open door state (a reversal motion).

In some examples the second event may be an event other than an elevator door motion event. In some examples the second event is an elevator car start or an elevator car stop event. An elevator car start event may be the departure of the elevator car from a landing. An elevator car stop event may be the arrival of the elevator car at a landing. Such information is useful in the categorization of elevator door motion events as it is known with a high degree of certainty that the first elevator door motion following an elevator car stop must be a door opening event. Likewise the last elevator door motion preceding an elevator car start must be a door closing event as the elevator car cannot depart with open doors.

In some examples the second event is an earlier elevator door motion event. Such information is useful in that comparison of one elevator door motion event with another elevator door motion event of known category allows for a matching (or non-matching) of category to be made.

In some examples the second event is an earlier elevator door opening event. For example, by comparing the first event to an earlier door opening event and establishing that the sensor data for the first event corresponds to (to a suitable degree) the sensor data for the second event, it can be ascertained that the first event is also a door opening event. It will be appreciated that similar comparisons may also be made where the second event corresponds to a door closing event or where the second event corresponds to a door reversal event. However, it is particularly convenient to use an earlier door opening event as the second event because, as discussed above, door opening events can be identified with high reliability based on detecting an elevator car stop event and taking the first door motion event following the elevator car stop event as a door opening event. Thus in some examples, the second event is the first elevator door opening event following the most recent elevator car stop event. It will be appreciated that the second event may be a different door opening event (i.e. other than the one following the most recent car stop event). For example, a door open event immediately following an earlier (but not the most recent) car stop event could also be used. This may be useful where sensor data indicates that the first elevator door motion following the car stop event is of low quality and therefore not ideal for use in future comparisons. In such cases an earlier and higher quality door opening event may be used. Such earlier door opening event may be from the same or a different landing, but is ideally from the same landing as door motion signatures may vary between landings. It will be appreciated that the same principles apply where the comparison is to be made with an earlier door closing event or earlier door reversal event.

In some examples the controller is arranged to categorize the first event based on a correspondence of the sensor data for the first event and the sensor data for the second event. Determining correspondence may take many different forms. For example, while an exact match of sensor data for the two events could be required, the variability in sensor data makes this unattractive. Instead, the correspondence will generally be a certain degree of correspondence. Any suitable matching algorithms may be used which can allow for some degree of mismatch in the data while still assuring overall correspondence sufficient to give a high confidence that the two events are of the same category. In some examples, the sensor data may be processed to generate a signature which is indicative of a type of motion and the correspondence of the sensor data for the first event and second event may comprise generating the signature for each event and comparing the signatures for correspondence. Purely by way of example, some elements of a suitable signature may comprise the direction of motion of the elevator door as determined by the accelerometer, the duration of elevator door motion, the relative time order of the minimum and maximum acceleration within the accelerometer data. In some examples the signature may comprise one or more frequency components of the door motion data.

In some examples categorizing the first event comprises at least one of: categorizing the first event as a door open event; categorizing the first event as a door close event; and categorizing the first event as a door reversal event. It will be appreciated that it is not always necessary to use all of these categories. For example it may be sufficient to identify only the door reversal events, or only the door opening events or only the door closing events. In some examples, the monitoring system uses the opening and reversal categories. In some examples it may be determined that the number of door closing events is equal to the number of door opening events during a given landing stop, i.e. between an elevator car stop and the next elevator car start (which would be true if no errors are made in categorization).

In some examples categorizing the first event comprises adjusting a counter corresponding to a category. The act of matching or not matching a set of criteria amounts to the categorization being made and the adjustment of a corresponding counter dependent on that matching or not matching amounts to logging or storing the categorization. It will be appreciated that in other examples the categorization may be stored or logged in other ways. For example a list of detected events may be generated, each with an associated determined category. However, the use of a counter to log the events is sufficient for many analysis purposes and the counter value provides a simple and low data metric that can be transmitted at low power and low cost to a monitoring station.

In some examples categorizing the first event is based on an amount of time between the first event and the second event. For example, in some systems, the amount of time that an elevator door can spend idle between a door opening event and a door closing event is limited (i.e. the elevator doors will always be instructed to close after a predefined period of time following an opening event). In such cases, determining that the amount of time since the last door motion event has exceeded a threshold period of time is a reliable indicator that the elevator doors are currently in a closed state. In other words, where the first event and second event are adjacent (in time) door motion events, the knowledge that the time between first and second events exceeds the maximum door open idle time can be used to determine with high reliability that the first event (the more recent event) is a door opening event. Thus, in some examples when the second event precedes the first event by a predetermined amount of time, the controller is arranged to categorize the first event as a door open event.

In some examples categorizing the first event is based on a previously determined state of the elevator door. For example, a full door closing event may be used to set a system state to “door closed”. Likewise a full door opening event may be used to set a system state to “door open”. It can be inferred that the next door motion following a “door closed” state must be a door open event. Likewise it can be inferred that the next door motion following a “door open” state must be either a door closing event or a door reversal event. Therefore basing categorization of the first event on a previously determined state of the elevator door adds additional information and additional diagnostic capability. When the previous door state is combined with the analysis of the first event and second event, errors in the analysis can also be determined. For example, if a door state indicates that door is in an open state and the first event also matches a second event which was an earlier door open event then it can be determined that an error has occurred (the system has detected two door opening events in a row, without detecting an intervening door closing event) and suitable processing can be effected.

The analysis discussed in this disclosure is particularly applicable to low power systems which operate on a battery and/or energy harvesting power source. This is the case in monitoring or diagnostic systems (e.g. condition based maintenance systems) which do not have direct access to the elevator drive machinery and which must therefore determine the elevator car and/or door motions independently. It is convenient for such systems to operate on their own power source (battery or energy harvesting) as this makes them much easier and quicker to install, especially as a retrofit on older elevator systems. In addition, for ease of installation such systems conveniently communicate via wireless transmission so as to avoid the need for hard-wired connections. As such wireless transmissions are power intensive, minimising the amount of data to be transmitted is highly desirable. Additionally, intensive signal processing for complex analysis consumes power and it is also desirable to minimise processing in order to conserve power and extend battery life. Higher sampling rates of sensor data allow more accurate analysis and determination of motion profiles. However, higher sampling rates consume more power and also processing the larger resulting data sets can consume more power. In the examples described here, the analysis of door motion is sufficiently robust to operate on low sample rates and correspondingly small data sets. Therefore the processing power is reduced while still maintaining high reliability of diagnostics and monitoring. In some examples the sensor data (e.g. accelerometer data) is acquired at a sample rate of no more than 100 samples per second, or no more than 50 samples per second, or no more than 20 samples per second. Of course it will be appreciated that the processing techniques described here may also be applied in cases where power and/or data transmission are not limiting factors and therefore in some examples any desired sampling rate may be used.

As discussed above, in some examples the elevator monitoring system is powered by a battery or energy harvesting system. An energy harvesting system may for example comprise an inductive charging system or it may comprise a thermal, kinetic or wind-based system. In some examples the monitoring system is not connected to mains power. With battery or energy harvesting powered systems, low power operation becomes very important and therefore the amount of intensive processing, the sensor sampling rates and wireless transmission strengths become important factors in achieving a suitably long operational lifetime between servicing.

In some examples the monitoring system is independent from the elevator system. As discussed above, this facilitates installation as no communicative connections to the existing system controllers are required. Health monitoring can thereby be achieved from an independent system and adds a layer of safety on top of the fault detection and monitoring systems within the elevator system itself.

It will be appreciated that the monitoring system may be designed to process data at any of a number of different points within the system. In some examples data is processed locally on a monitoring device that is mounted to the elevator car (e.g. to the elevator car door). Processing data locally at the point of acquisition reduces the amount of wireless data transmission and therefore reduces power consumption, but also increases the power consumed in processing the data. In other examples data may be transmitted to a remote location for processing. The remote location may have different or less strict power consumption limitations and may therefore be capable of performing more detailed and complex data analysis. The remote location may be an on-site gateway (i.e. on the same site as the elevator itself) or it may be on another remote site or in the cloud. Where data is processed locally, the results (e.g. diagnostic metrics) may be transmitted either directly to an on-site or remote or cloud based monitoring station or may be transmitted to such a monitoring system via a local gateway.

According to a second aspect of the present disclosure, there is provided a method of monitoring an elevator system comprising: acquiring sensor data from one or more sensors; analysing the sensor data to identify a first event and a second event, the first event corresponding to an elevator door motion; categorize the first event based on the sensor data for the first event and the second event. It will be appreciated that all of the optional or example features discussed above in relation to the monitoring system can equally optionally apply to this method of monitoring an elevator system.

### BRIEF DESCRIPTION OF DRAWINGS

FIG. 1 is a schematic illustration of an elevator system according to examples of the present disclosure;

FIG. 2 is a schematic illustration of a sensor system for the elevator system of FIG. 1, according to examples of the present disclosure;

FIG. 3 is a schematic illustration of the location of a sensor system for the elevator system of FIGS. 1 and 2, according to examples of the present disclosure;

FIG. 4 is a schematic illustration of a sensing unit according to examples of the present disclosure;

FIG. 5 illustrates a process for elevator door monitoring;

FIG. 6 is a flow chart of a first example of a door monitoring process;

FIG. 7 is a flow chart of a second example of a door monitoring process; and

FIG. 8 shows an algorithm with pseudo-code for a door monitoring process similar to FIG. 7.

### DETAILED DESCRIPTION

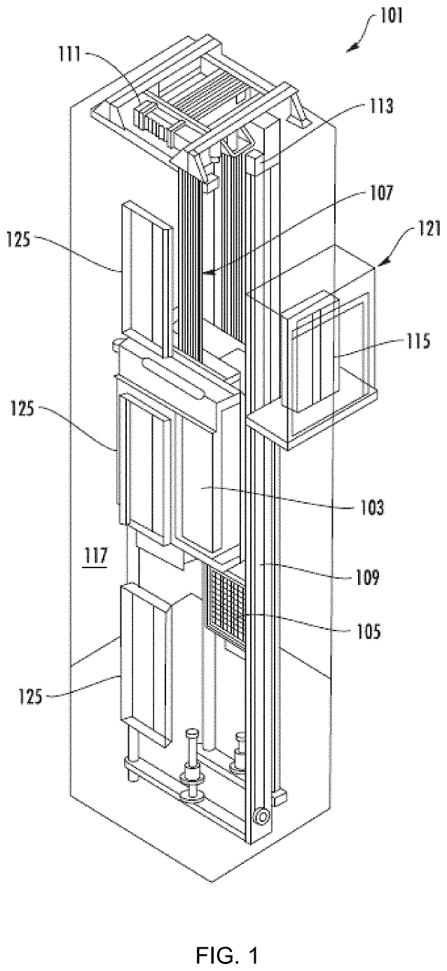

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor or pinched wheel propulsion to impart motion to an elevator car. Embodiments may also be employed in ropeless elevator systems using a hydraulic lift to impart motion to an elevator car. FIG. 1 is merely a non-limiting example presented for illustrative and explanatory purposes.

In other embodiments, the system comprises a conveyance system that moves passengers between floors and/or along a single floor. Such conveyance systems may include escalators, people movers, etc. Accordingly, embodiments described herein are not limited to elevator systems, such as that shown in FIG. 1. In one example, embodiments disclosed herein may be applicable to conveyance systems such as an elevator system 101 and a conveyance apparatus of the conveyance system such as an elevator car 103 of the elevator system 101. In another example, embodiments disclosed herein may be applicable to conveyance systems such as an escalator system and a conveyance apparatus of the conveyance system such as a moving stair of the escalator system.

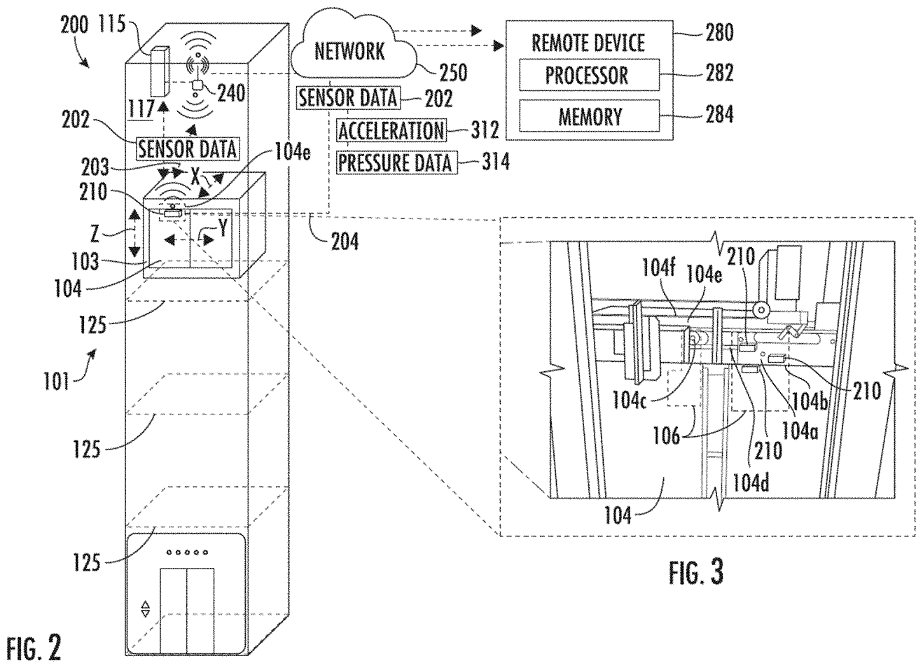

Referring now to FIG. 2, with continued referenced to FIG. 1, a view of a sensor system 200 including a sensing apparatus 210 is illustrated, according to an embodiment of the present disclosure. The sensing apparatus 210 is configured to detect sensor data 202 of the elevator car 103 and transmit the sensor data 202 to a remote device 280. Sensor data 202 may include but is not limited to pressure data 314, vibratory signatures (i.e., vibrations over a period of time) or accelerations 312 and derivatives or integrals of accelerations 312 of the elevator car 103, such as, for example, distance, velocity, jerk, jounce, snap . . . etc. Sensor data 202 may also include light, sound, humidity, and temperature, or any other desired data parameter. The pressure data 314 may include atmospheric air pressure within the elevator shaft 117. It should be appreciated that, although particular systems are separately defined in the schematic block diagrams, each or any of the systems may be otherwise combined or separated via hardware and/or software. For example, the sensing apparatus 210 may be a single sensor or may be multiple separate sensors that are interconnected.

In an embodiment, the sensing apparatus 210 is configured to transmit sensor data 202 that is raw and unprocessed to the controller 115 of the elevator system 101 for processing. In another embodiment, the sensing apparatus 210 is configured to process the sensor data 202 prior to transmitting the sensor data 202 to the controller 115 through a processing method, such as, for example, edge processing. In another embodiment, the sensing apparatus 210 is configured to transmit sensor data 202 that is raw and unprocessed to a remote system 280 for processing. In yet another embodiment, the sensing apparatus 210 is configured to process the sensor data 202 prior to transmitting the sensor data 202 to the remote device 280 through a processing method, such as, for example, edge processing.

The processing of the sensor data 202 may reveal data, such as, for example, a number of elevator door openings/closings, elevator door time, vibrations, vibratory signatures, a number of elevator rides, elevator ride performance, elevator flight time, probable car position (e.g. elevation, floor number), releveling events, rollbacks, elevator car 103 x, y acceleration at a position: (i.e., rail topology), elevator car 103 x, y vibration signatures at a position: (i.e., rail topology), door performance at a landing number, nudging event, vandalism events, emergency stops, etc.

The remote device 280 may be a computing device, such as, for example, a desktop, a cloud based computer, and/or a cloud based artificial intelligence (AI) computing system. The remote device 280 may also be a mobile computing device that is typically carried by a person, such as, for example a smartphone, PDA, smartwatch, tablet, laptop, etc. The remote device 280 may also be two separate devices that are synced together, such as, for example, a cellular phone and a desktop computer synced over an internet connection.

The remote device 280 may be an electronic controller including a processor 282 and an associated memory 284 comprising computer-executable instructions that, when executed by the processor 282, cause the processor 282 to perform various operations. The processor 282 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 284 may be but is not limited to a random access memory (RAM), read only memory (ROM), or other electronic, optical, magnetic or any other computer readable medium.

The sensing apparatus 210 may be configured to transmit the sensor data 202 to the controller 115 or the remote device 280 via short-range wireless protocols 203 and/or long-range wireless protocols 204. Short-range wireless protocols 203 may include but are not limited to Bluetooth, Wi-Fi, HaLow (801.11ah), zWave, ZigBee, or Wireless M-Bus. Using short-range wireless protocols 203, the sensing apparatus 210 is configured to transmit the sensor data 202 directly to the controller 115 or to a local gateway device 240 and the local gateway device 240 is configured to transmit the sensor data 202 to the remote device 280 through a network 250 or to the controller 115. The network 250 may be a computing network, such as, for example, a cloud computing network, cellular network, or any other computing network known to one of skill in the art. Using long-range wireless protocols 204, the sensing apparatus 210 may be configured to transmit the sensor data 202 to the remote device 280 through a network 250. Long-range wireless protocols 204 may include but are not limited to cellular, satellite, LTE (NB-IoT, CAT M1), LoRa, Satellite, Ingenu, or SigFox.

The sensing apparatus 210 may be configured to detect sensor data 202 including acceleration in any number of directions. In an embodiment, the sensing apparatus may detect sensor data 202 including accelerations 312 along three axes, an X axis, a Y axis, and a Z axis, as show in in FIG. 2. The X axis may be perpendicular to the doors 104 of the elevator car 103, as shown in FIG. 2. The Y axis may be parallel to the doors 104 of the elevator car 103, as shown in FIG. 2. The Z axis may be aligned vertically parallel with the elevator shaft 117 and the pull of gravity, as shown in FIG. 2. The acceleration data 312 may reveal vibratory signatures generated along the X-axis, the Y-axis, and the Z-axis.

FIG. 3 shows a possible installation location of the sensing apparatus 210 within the elevator system 101. The sensing apparatus 210 may include a magnet (not show) to removably attach to the elevator car 103. In the illustrated embodiment shown in FIG. 3, the sensing apparatus 210 may be installed on the door hanger 104a and/or the door 104 of the elevator system 101. It is understood that the sensing apparatus 210 may also be installed in other locations other than the door hanger 104a and the door 104 of the elevator system 101. It is also understood that multiple sensing apparatus 210 are illustrated in FIG. 3 to show various locations of the sensing apparatus 210 and the embodiments disclosed herein may include one or more sensing apparatus 210. In another embodiment, the sensing apparatus 210 may be attached to a door header 104e of a door 104 of the elevator car 103. In another embodiment, the sensing apparatus 210 may be located on a door header 104e proximate a top portion 104f of the elevator car 103. In another embodiment, the sensing apparatus 210 is installed elsewhere on the elevator car 103, such as, for example, directly on the door 104.

As shown in FIG. 3, the sensing apparatus 201 may be located on the elevator car 103 in the selected areas 106, as shown in FIG. 3. The doors 104 are operably connected to the door header 104e through a door hanger 104a located proximate a top portion 104b of the door 104. The door hanger 104a includes guide wheels 104c that allow the door 104 to slide open and closed along a guide rail 104d on the door header 104e. Advantageously, the door hanger 104a is an easy to access area to attach the sensing apparatus 210 because the door hanger 104a is accessible when the elevator car 103 is at landing 125 and the elevator door 104 is open. Thus, installation of the sensing apparatus 210 is possible without taking special measures to take control over the elevator car 103. For example, the additional safety of an emergency door stop to hold the elevator door 104 open is not necessary as door 104 opening at landing 125 is a normal operation mode. The door hanger 104a also provides ample clearance for the sensing apparatus 210 during operation of the elevator car 103, such as, for example, door 104 opening and closing. Due to the mounting location of the sensing apparatus 210 on the door hanger 104a, the sensing apparatus 210 may detect open and close motions (i.e., acceleration) of the door 104 of the elevator car 103 and a door at the landing 125. Additionally mounting the sensing apparatus 210 on the hanger 104a allows for recording of a ride quality of the elevator car 103.

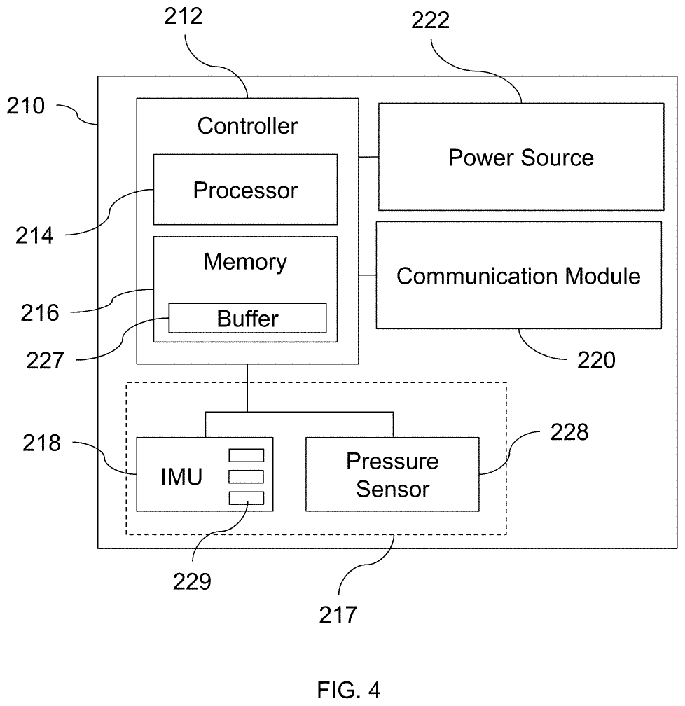

FIG. 4 illustrates an example of a sensing apparatus 210 of FIGS. 2 and 3 in more detail. The sensing apparatus includes a controller 212, a plurality of sensors 217 in communication with the controller 212, a communication module 220 in communication with the controller 212, and a power source 222 electrically connected to the controller 212. The plurality of sensors 217 includes an inertial measurement unit (IMU) 218 and a pressure sensor 228. The IMU 218 comprises three accelerometers 229 and is configured to detect acceleration of the elevator car 103 and/or elevator car door 104, and to generate the acceleration data 312. The pressure sensor 228 (which may be, for example a pressure altimeter or a barometric altimeter) is configured to detect an atmospheric air pressure within the elevator hoistway 117, and to generate the pressure data 314. Both the IMU 218 and the pressure sensor 228 are in communication with the controller 212 of the sensing apparatus 210. It will be appreciated that while the pressure sensor 228 may be used to provide further information on elevator car 103 movement, it can also be omitted in some examples. In some examples, the plurality of sensors 217 may also include additional sensors such as a light sensor, a microphone, a humidity sensor, and a temperature sensor.

The power source 222 of the sensing apparatus 210 is configured to store and supply electrical power to the sensing apparatus 210. The power source 222 may include an energy storage system, such as a battery or a capacitor, or other appropriate energy storage system known in the art.

The communication module 220 is configured to allow the controller 212 of the sensing apparatus 210 to communicate with the remote device 280 and/or controller 115 through at least one of short-range wireless protocols 203 and long-range wireless protocols 204 as described above.

The controller 212 of the sensing apparatus 210 includes a processor 214 and a memory 216 comprising computer-executable instructions that, when executed by the processor 214, cause the processor 214 to perform various operations such as processing of the sensor data 202 collected by the IMU 218 and the pressure sensor 228 to determine information about the motion of the elevator car 103. The sensing apparatus 210 also comprises a buffer 227, configured to store a pre-set number of data entries.

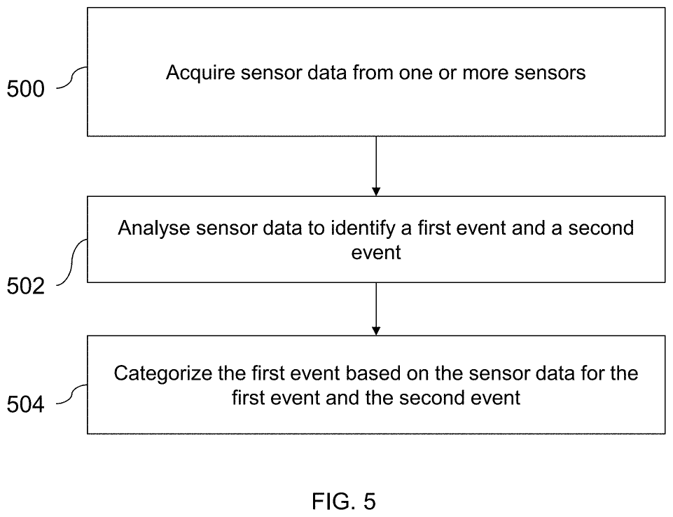

FIG. 5 illustrates an example of a method of categorizing door motion based on sensor data. The method begins at step 500 in which sensor data is acquired from one or more sensors. The one or more sensors may be one accelerometer 229 or a set of accelerometers (e.g. IMU 218) which may include a set of three mutually orthogonal accelerometers, or it may include one or more of the additional sensors discussed above. In step 502 the sensor data that was acquired in step 500 is analysed to identify a first event and a second event within the data. The first event is the door 104 motion that is to be categorized by this process. The second event is another event that may be another door 104 motion event or may be an elevator car 103 motion event. Where the second event is another door 104 motion event, it may for example be a door 104 opening event or a door 104 closing event or a door 104 reversal event. Where the second event is a car 103 motion event, it may for example be a car 103 start event (leaving a landing 125) or a car 103 stop event (arriving at a landing 125). In step 504 the first event is categorized based on the sensor data for the first event and the sensor data for the second event. In this step the first event is categorized not only based on the sensor data acquired in respect of that first event, but also based on the sensor data acquired in respect of the second event. Therefore, the categorization is based on knowledge of some other system motion (which occur before or after the first event). Taking into account this additional sensor data for a second event means that the sensor data can be acquired at a lower rate (i.e. lower time resolution data) while still acquiring sufficient information to make an accurate categorization of the first event. The data that is acquired for the second event will in many cases be acquired as part of normal system operation anyway. Therefore, this system makes use of additional information that is already present, while allowing a low sampling rate to be used for the sensor data. It should be noted that not all sensor data from different sensors needs to be acquired at the same rate and can be selected according to the sensor and the needs of the system.

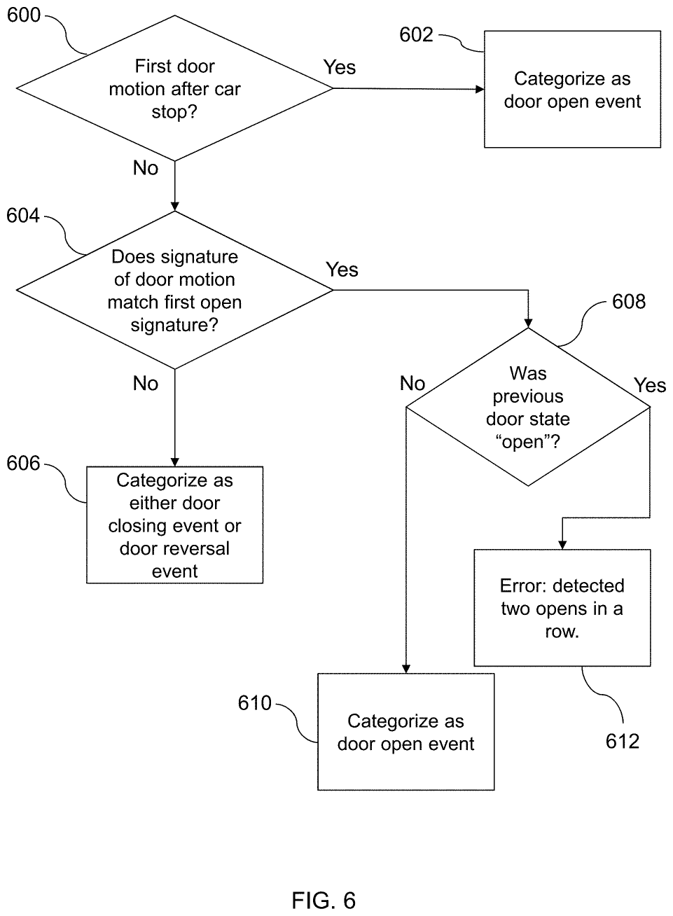

FIG. 6 shows in detail one example of a categorization process that can be used to categorize a door 104 motion. Starting at step 600, the process checks if this is the first door 104 motion since the car 103 stopped at a landing 125. If “Yes”, then in step 602 the door 104 motion event is categorized as a door opening event. This is based on the assumption that the door 104 is closed when the elevator car 103 comes to a stop at the landing 125 and therefore the next door 104 motion must be a door opening event. In this case, the second event is a car 103 motion event and the first event is categorized based on the first event (motion is detected) and the second event (car stop event detected). If step 600 concludes that the door motion is not the first motion after the car 103 has come to a stop (“No”) then the process proceeds to step 604 for further analysis. In step 604 the process checks if the door 104 motion signature matches a first door open signature. If “Yes”, then the process proceeds to step 608 in which the process checks if the last known door 104 state was “open”. If “Yes” then an error has occurred as a door 104 open event has apparently been detected when the door state was already thought to be open. Therefore in step 612 an error is noted. Additional processing may be performed to handle the error (an example is provided below). If the previous door state was not “open” (“No” from step 608) then the process proceeds to step 610 in which the door 104 motion event is categorized as a door open event. In this case the door 104 motion event (i.e. the first event) has been categorized based on the first event (door motion detected), based on the second event (the first open signature that it was compared against in step 604) and a previous system state (the door open state that was checked in step 608). Finally, if the comparison in step 604 between the door 104 motion event (first event) and the first door open signature (second event) is “No” then it is determined that the door 104 motion is not an opening event and therefore in step 606 the door 104 motion is categorized as either a door closing event or a door reversal event.

In the process of FIG. 6, no distinction is made between door closing events and door reversal events. This degree of categorization may be sufficient for diagnostic and monitoring purposes. However, if further separation of the closing and reversal events is required than further analysis can be performed. For example comparisons of the motion signature against known closing events or known reversal events may be made. However, in some examples the number of door closings can be determined based on data already available. For example the number of full door opening events and full door closing events should be equal. Alternatively, an event that was categorized in step 606 as either a door closing event or a door reversal event can be further categorized based on detecting that the next event is either a door 104 opening event (which can only occur if the doors 104 fully closed) or a car 103 start event (which can only occur if the doors 104 fully closed). In the first case, the further categorization has again been categorized based on two door 104 motion events (a closing/reversal event followed by an opening event) and in the second case, the further categorization has again been categorized based on a door 104 motion event and a car 103 motion event (a closing/reversal event followed by a car start event). In some examples, categorizing the door reversal events is the most important for characterizing the health of the door 104.

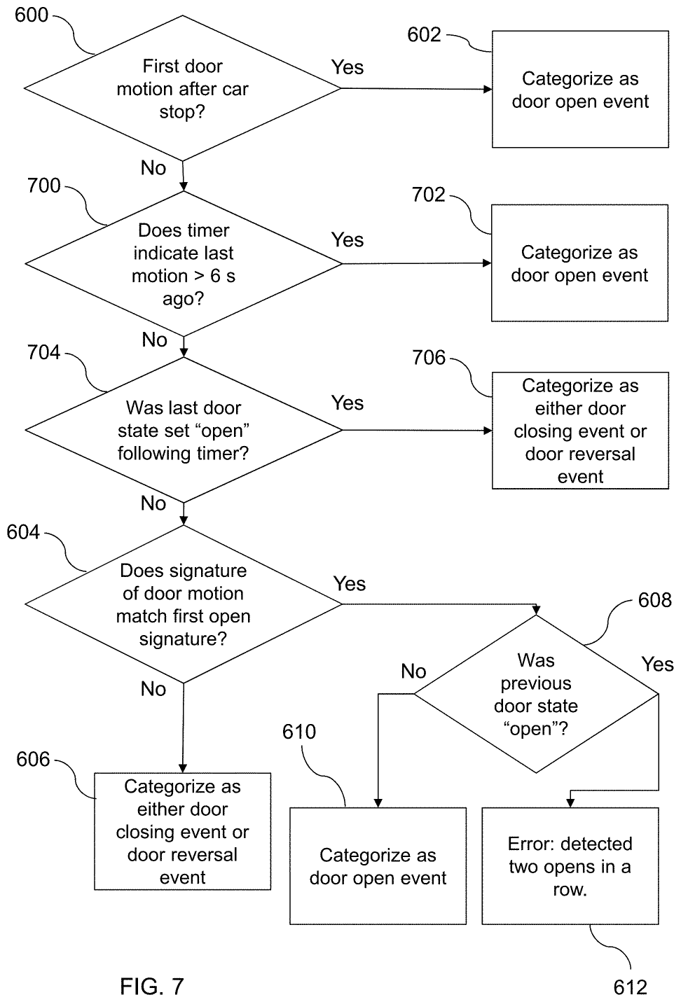

FIG. 7 shows another example of a categorization process. The process of FIG. 7 is similar to that of FIG. 6, but contains some additional steps. The steps that are the same as in FIG. 6 are labelled with the same reference numbers and will not be described again here. In the example process of FIG. 7, if the determination in step 600 is that the door 104 motion is not the first door 104 motion following an elevator car 103 stop event, then the process proceeds to step 700. In step 700 the process checks if the time since the last door 104 motion is greater than 6 seconds (although it will be appreciated that this time is given by way of example only and that any suitable time threshold could be used according to the particular elevator system being monitored). If the time since the last door 104 motion is greater than 6 seconds (“Yes” from step 700) then the process proceeds to step 702 in which the door 104 motion (i.e. the first event) is categorized as a door open event. This analysis is based on the system knowledge that the elevator door 104 does not normally remain open for 6 seconds at a time without attempting a close motion. Therefore if the door 104 has remained stationary for greater than 6 seconds, it may be inferred that the door 104 motion must be an opening event. In this case, the categorization has been based on two door motion events (the current door 104 motion event, i.e. the first event, and a time since the previous door 104 motion event, i.e. the second event). If the analysis in step 700 is “No” then the process proceeds to step 704 in which the process checks whether the last door state was set to “open” following a timer-based determination. If “Yes” then the process proceeds to step 706 in which the door 104 motion (i.e. the first event) is categorized as either a door closing event or a door reversal event. This categorization step is similar to the categorization in step 606, but in this case the categorization is made on the basis that a door open state was reliably determined after the previous motion. Therefore, it can now reliably be confirmed that the current motion is a non-opening event. As with step 606 discussed above, further processing may be performed to further categorize the closing events and the reversal events. If the determination in step 704 is “No” then the process proceeds to step 604 which then proceeds in the same way as was discussed above with reference to FIG. 6. It will be appreciated that in some examples steps 704 and 706 could be omitted as the door close/reversal should fail the signature check in step 604 and get counted at step 606. However, the identification following the timer is considered a more reliable determination and therefore gives a more trustworthy categorization. Therefore steps 704 and 706 provide more reliable categorization.

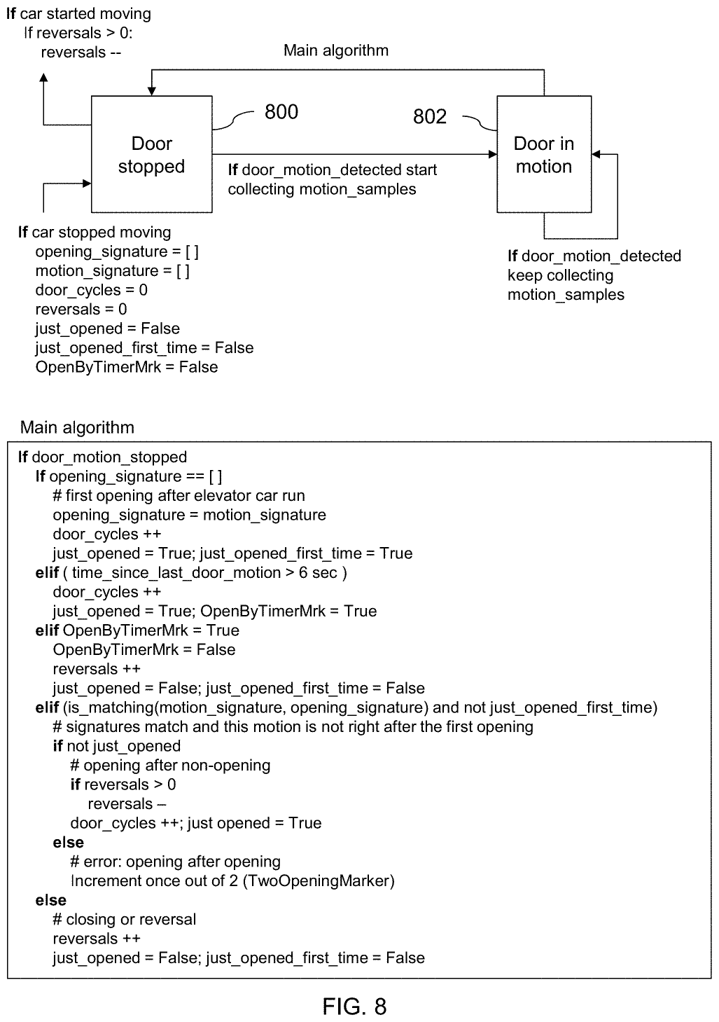

FIG. 8 shows an example of an algorithm which carries out the process according to the example of FIG. 7. The upper part of FIG. 8 shows how the algorithm moves between a door 104 stopped state 800 and a door 104 in motion state 802. Starting with the door stopped state 800, when door motion is detected (e.g via one or more accelerometer samples) then the flag door_motion_detected is set to True and the algorithm starts acquiring motion_samples which is an array of sensor data acquired from the one or more sensors. The door is then considered to be in the door in motion state 802. In this state 802, the algorithm continues to acquire motion_samples while the door_motion_detected flag remains True. When the door 104 stops moving, the door_motion_detected flag changes to False and the algorithm returns from door in motion state 802 to door stopped state 800 via the main algorithm which is set out as pseudo-code in the lower part of FIG. 8.

The main algorithm of FIG. 8 will now be described briefly. Firstly the flag door_motion_stopped is checked. This corresponds to the change of state from state 802 to state 800 in the upper part of the figure and is the trigger for the main algorithm to commence. The algorithm then checks if opening_signature is an empty array. The array opening_signature is a set of values derived from the motion_samples array that was acquired during an earlier door 104 opening event. This signature is ideally acquired from the first door 104 motion event following the elevator car 103 stopping at a landing 125 as this event is reliably determined to be an opening event. The signature (defined by the opening_signature array) is a set of values that characterize the motion and may include for example the direction of motion as determined by the accelerometer, the duration of the motion, the relative position of the minimum and maximum acceleration values in the data, etc. If the opening_signature array is empty then no such signature has yet been determined and therefore this must be the first door 104 motion following an elevator car 103 stop. Therefore, the opening_signature array is set to be equal to the motion_signature array which is the signature calculated for the current door 104 motion event (derived from the motion_samples array). In addition, the counter door_cycles is incremented by one to reflect that the first door 104 motion following an elevator car stop is categorized as a door open event as per step 602 of FIG. 7. Further, the two status flags just_opened and just_opened_first_time are set to True.

If the door motion was not the first since car stop then the algorithm next checks if the variable time_since_last_door_motion is greater than 6 seconds. This corresponds to the check in step 700 of FIG. 7 and if True the algorithm increments the counter door_cycles by one to reflect the categorization of a door open event in step 702 of FIG. 7. Additionally the flag just_opened is set to True to reflect the known door state as opened and the flag OpenByTimerMrk is set to True to reflect that the current door open state was determined by the timer.

If the time since last door motion was not greater than 6 seconds then the algorithm next checks if the OpenByTimerMrk is True corresponding to processing step 704 in FIG. 7. If it is then the flag OpenByTimerMrk can now be reset to False and a counter reversals is incremented by one to reflect that the door motion event is not a door opening event. Here it should be noted that the counter “reversals” is incremented if the current door motion is either a door closing event or a door reversal event. However, as discussed further below, the closing events will subsequently by removed by further categorization and thus the counter will end up reflecting only door reversal events. In this step, the flag just_opened is set to False to reflect that the door is not known to be in the open state (it could now be in a closed state following a close event or in an open state following a reversal event). Also, the just_opened_first_time flag is set to False.

If it is determined that the last motion state was not set by the timer then the algorithm next checks whether the motion_signature array for the current door 104 motion matches the opening_signature array determined at the start of the main algorithm when the first door motion after car stop was detected. This corresponds to the step 604 in FIG. 7. It may be noted that the is_matching comparison function need not require an exact match, but may instead allow for matching to within a certain degree, e.g. for the various values to be within certain tolerances or thresholds of each other. A check is also made that the flag just_opened_first_time is not set. The motion following the first door motion should not be determined as an opening event and therefore this check makes sure to avoid the following processing. This allows a special use of the is_matching( ) function which is not shown in the figures—as it is known that the is_matching( ) function should return false on the first motion following the first door opening, a return of true can be used to indicate a poor quality signature acquisition during the first opening motion. If such a poor quality signature is determined, an alternative signature, previously validated signature (e.g. from a previous run or from a different landing) can be used instead. In the case that motion_signature is determined to match opening_signature and the flag just_opened_first_time is not set, then the algorithm next checks if the flag just_opened is set. If the flag just_opened is not set then it is determined that the current motion represents an opening event following a non-opening event. An opening event can only happen after a closing event has taken place and therefore it may be assumed that a full closing event has occurred (and should have been counted by the reversals counter). Therefore, a check is made (for safety) that the reversals counter is greater than zero (which it should be) and then the reversals counter is decremented by one to remove the full closing event from the count. In addition, the counter door_cycles is incremented by one to reflect the categorization of the current motion as a door opening event. This corresponds to step 610 in FIG. 7. Additionally, the flag just_opened is set to True to reflect the known door state as opened.

If the door signatures matched following the is_matching comparison, but the flag just_opened was set to True then the algorithm determines that an error has occurred as a door opening signature has been found when the door state was already believed to be open. In this case something must have gone wrong with the algorithm or sensor data and some suitable action may be taken. In this example the door_cycles counter is incremented once out of every two times that this situation occurs to reflect that counting all of the openings would be an overestimate. This corresponds to step 612 in FIG. 7.

More specifically, although this error processing is not set out in detail in FIG. 8, one example is to operate as follows: The variable named TwoOpeningMrk evolves between the values 0 and 1 which each error detection. The first time the situation occurs, TwoOpeningMrk takes value 1 and the number of openings is not incremented. The next time the situation occurs, TwoOpeningMrk takes value 0 and the number of opening is incremented by one. Next time TwoOpeningMrk takes value 1 and the number of opening is not incremented, and so on. At the very end, when the car moves, if the flag just_open is True and TwoOpeningMark is 0, then the counter for the number of cycles is decremented. It will be appreciated that this is just one example of an error processing routine and that many alternatives exist.

Finally, if none of the above checks have been triggered, the final step is to categorize the door 104 motion as a closing event or reversal event. Thus, the reversals counter is incremented by one, the just_opened flag is set to False and the just_opened_first_time flag is set to False to represent that the door is not known to be in an open state. This corresponds to step 606 in FIG. 7.

Returning to the upper part of FIG. 8, following the return to the door stopped state 800, if the elevator car then starts to move, it can be assumed that a full door closing event has taken place. Therefore, the reversals counter is decremented by one to remove the door closing event that should have been counted earlier in the processing (after a confirmatory check that the reversals counter is indeed greater than zero).

Here it is also shown that when a determination is made that the car stopped moving, an initialisation of variables is performed to set the opening_signature array to empty, the motion_signature array to empty, the door_cycles counter to zero, the reversals counter to zero, the just_opened flag to False, the just_opened_first_time flag to False and the OpenByTimerMrk flag to False.

It will be appreciated by those skilled in the art that the disclosure has been illustrated by describing one or more specific examples thereof, but is not limited to these examples; many variations and modifications are possible, within the scope of the accompanying claims.

What is claimed is:

1. An elevator monitoring system, comprising:
one or more sensors;
a controller arranged to:
acquire sensor data from the one or more sensors;
analyse the sensor data to identify a first event and a second event, the first event corresponding to an elevator door motion;
categorize the first event based on the sensor data for the first event and the second event.

2. An elevator monitoring system as claimed in claim 1, wherein the one or more sensors comprises an accelerometer and the controller is arranged to acquire accelerometer data.

3. An elevator monitoring system as claimed in claim 2, wherein the controller is arranged to analyse the accelerometer data to identify the first event.

4. An elevator monitoring system as claimed in claim 3, wherein identifying the first event comprises identifying a period of elevator door motion between two periods of the elevator door being stationary.

5. An elevator monitoring system as claimed in claim 1, wherein the second event is an elevator car start or an elevator car stop event.

6. An elevator monitoring system as claimed in claim 1, wherein the second event is an earlier elevator door motion event.

7. An elevator monitoring system as claimed in claim 6, wherein the second event is an earlier elevator door opening event.

8. An elevator monitoring system is claimed in claim 7, wherein the second event is the first elevator door opening event following the most recent elevator car stop event.

9. An elevator monitoring system as claimed in claim 6, wherein the controller is arranged to categorize the first event based on a correspondence of the sensor data for the first event and the sensor data for the second event.

10. An elevator monitoring system as claimed in claim 1, wherein categorizing the first event comprises at least one of:
categorizing the first event as a door open event;
categorizing the first event as a door close event; and
categorizing the first event as a door reversal event.

11. An elevator monitoring system as claimed in claim 1, wherein categorizing the first event comprises adjusting a counter corresponding to a category.

12. An elevator monitoring system as claimed in claim 1, wherein categorizing the first event is based on an amount of time between the first event and the second event.

13. An elevator monitoring system as claimed in claim 12, wherein when the second event precedes the first event by a predetermined amount of time, the controller is arranged to categorize the first event as a door open event.

14. An elevator monitoring system as claimed in claim 1, wherein categorizing the first event is based on a previously determined state of the elevator door.

15. A method of monitoring an elevator system comprising:
acquiring sensor data from one or more sensors;
analysing the sensor data to identify a first event and a second event, the first event corresponding to an elevator door motion;
categorize the first event based on the sensor data for the first event and the second event.
